(19) United States
(12) Patent Application Publication
(10) Pub. No.: US 2008/0033947 A1
(43) Pub. Date: Feb. 7, 2008

(54) RATING SYSTEM AND METHOD OF MONITORING RATINGS

(76) Inventors: Adam Bermingham, Dundrum (IE); Declan Fahey, Loughrea (IE); Brendan Patrick Murray, Coolfore (IE); William Graham O'Keeffe, Blanchardstown (IE)

Correspondence Address: LOTUS AND RATIONAL SOFTWARE;McGuinness & Manaras LLP, 125 NAGOG PARK, ACTON, MA, 01720, US

(21) Appl. No.: 11/611,871

(22) Filed: Dec. 17, 2006

(30) Foreign Application Priority Data
Aug. 4, 2006 (GB) GB0615503.0

(51) Int. Cl. G06F 17/30

(52) U.S. Cl. 707/7

(57) ABSTRACT

A rating system is provided including means for a user to submit a rating with an indication of the identity of the user. A retrieval means retrieves a user group type from a directory using the indication of the identity of the user. A storage means stores the rating together with an indication of the user type and a time stamp. A graphical user interface (GUI) is provided for displaying ratings over time, including ratings for different user types.

### CROSS REFERENCE TO RELATED APPLICATIONS

The present application claims priority under 35 USC 119 to United Kingdom Application Number GB0615503.0, filed Aug. 4, 2006.

### FIELD OF THE INVENTION

This invention relates to the field of rating systems. In particular, it relates to monitoring ratings over time.

### BACKGROUND OF THE INVENTION

Rating systems are used to obtain user feedback on items and services. The feedback can be provided to other users or to the item or service supplier. Rating systems are particularly popular for items and services available via the Internet, where there may not be other indications of value to a user.

Items which may be rated may include documents, web sites, feeds from web sites, goods for hire or sale, software packages, downloads, films, venues, etc. Services which may be rated may include Internet services such as on-line suppliers, on-line services, off-line services referenced by an on-line directory, etc. The nature of things that may be rated is infinite, as anything that can be experienced or used by a user can be rated.

The ratings of items and services can change over time. This may be due to the item or service having a time-related relevance such as a news story or new product. This is especially true in the software industry where a lot of goods and documents depreciate within a couple of years, whilst some are still relevant years later.

A good example is a document rating system in which web sites encourage users to rate a document to provide indications to other users of the document's relevance. Web site owners often use rating systems to monitor the usefulness of a document. User ratings of a document may change over time and this is not shown by the web sites. This information may be available if a user trawls through the comments and looks at the date submitted, but this is time consuming and may not be conclusive.

Furthermore, a document that is related to a software system may be of relevance to a programmer, but the same document may be of no relevance at all to a manager or business consultant. Search engines often use relevance feedback from various groups with similar interests to ascertain the relevance of a document. However, known user rating systems do not classify the ratings according to the type of user who submitted them.

It is an aim of the present invention to provide ratings of an item or service over time for different user types. This will distinguish how relevant an item or service is to a user based on the ratings given to it by various individuals over time.

### SUMMARY OF THE INVENTION

According to a first aspect of the present invention there is provided a rating system comprising: means for a user to submit a rating including an indication of the identity of the user; a directory providing details of user types; retrieval means for retrieving a user group type from the directory using the indication of the identity of the user; and a storage means for storing the rating together with an indication of the user type and a time stamp.

In one embodiment, the means for a user to submit a rating is a web site with a rating scale for an item or service.

The directory may be an employee's directory, a web users' directory, or a directory of user groupings. The indication of the identity of the user may be one of a name, email address, or Internet Protocol (IP) address.

The rating system may include a graphical user interface (GUI) for displaying ratings over time. The GUI may be provided by a web page viewable via a web browser.

The graphical user interface may display ratings for different user types. The displayed user types may be configurable by a user. The displayed time period may also be configurable by a user.

According to a second aspect of the present invention there is provided a method of monitoring ratings, comprising: receiving a rating from a user; determining a group type of the user; and storing the rating with a time stamp of the time of submission together with an indication of the group type of the user.

The method may include determining an identity of the user. The step of determining a group type of the user may retrieve user information from a directory based on the identity of the user.

The step of receiving a rating may receive a measure on a rating scale for an item or service.

The method may also include displaying ratings over time. Ratings for different user types may be displayed and this may be configurable by a user. The displayed time period may also be configurable by a user.

According to a third aspect of the present invention there is provided a computer program product stored on a computer readable storage medium, comprising computer readable program code means for performing the steps of: receiving a rating from a user; determining a group type of the user; storing the rating with a time stamp of the time of submission together with an indication of the group type of the user.

According to a fourth aspect of the present invention there is provided a method of providing a service to a customer over a network, the service comprising: receiving a rating from a user; determining a group type of the user; storing the rating with a time stamp of the time of submission together with an indication of the group type of the user.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a flow diagram of a method in accordance with the present invention;

FIG. 3 is a flow diagram of a method in accordance with the present invention; and

FIGS. 4A to 4D are graphical user interfaces showing graph outputs in accordance with the present invention.

### DETAILED DESCRIPTION OF EXEMPLARY EMBODIMENTS

Rating systems are provided for users to record their rating of something that they have used or experienced in order to provide an indication to other users of the standard of the experience. The types of things that may be rated are wide ranging from goods to services to experiences. With the advent of the Internet many rating systems are provided on-line, enabling anyone to contribute their rating. Ratings submitted by users are stored in a database referencing the rated item or service with the time that the rating was submitted and, optionally, the name or another indication of the user submitting it.

Items and services which have rating systems may take many different forms. Documents on the Internet in the form of items within web pages are one form of item for which a rating system is very useful. This example, is used to explain the invention further, although it should be appreciated that the rating system could be applied to many types of items and services whether read, downloaded, hired, sold, or otherwise used or experienced.

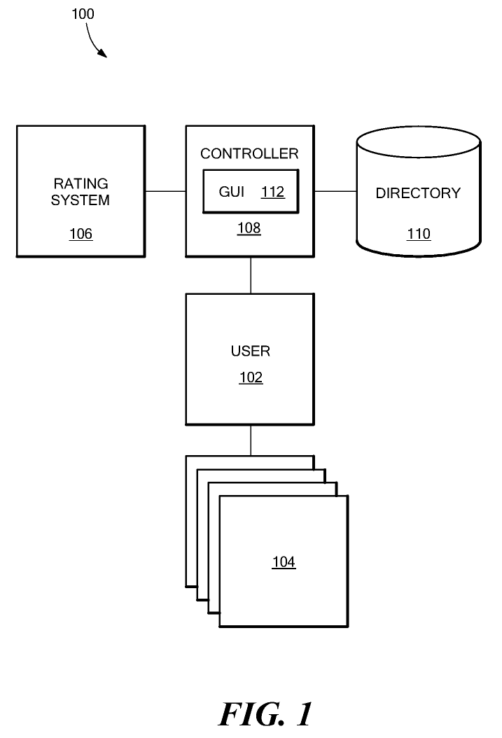

Referring to FIG. 1, a system 100 is shown in which a user 102 has access to a collection 104 of items or services. For example, the collection 104 may be provided via the Internet such as a document collection. The user 102 can evaluate the item or service of the collection 104 by providing a rating of relevance, usefulness, speed of service, reliability, or any other measure. The rating is often on a sliding scale, for example from 0 to 10; however, any form of rating measure may be used.

The user's rating together with other users' ratings are stored in a rating system 106. A controller 108 controls the rating system 106. In the described system, the controller 108 has access to user directories 110 which can determine a type or group of the user 102. For example, the user directory 110 may be a business employee directory providing details of the user's occupation, or it may be a user directory for a web site providing user's previously submitted details. The controller 108 can determine a type for a user 102 using the user's name, email address or other identifying means.

The controller 108 determines a type or group within which the user 102 can be categorized and adds this type to the user's rating stored in the rating system 106 together with a timestamp of the rating.

A graphical user interface 112 is provided for displaying the contents of the rating system 106 to users to provide guidance on the value of the rated items or services. In FIG. 1 the graphical user interface 112 is shown as part of the controller 108. The controller 108 may be incorporated into a rating system 106 or may be provided separately. The graphical user interface 112 may be part of the rating system 106 but separate from the controller 108 which retrieves the user type.

The graphical user interface 112 can display the results of the ratings of particular items or services against a time line to show how the ratings have varied over time. Furthermore, the graphical user interface 112 can display the results of the ratings according to the type of user in order to show the value of the item or service to a particular user type. A user can interrogate the graphical user interface 112 of the rating system 106 to show the types of users he is interested in over a time scale of interest.

The graphical user interface 112 allows a user to switch between bar, line and pie charts, and allows a user to view the graphs for any of the other groups monitored, and not just their own.

In one embodiment, the graphical user interface 112 may be a web page viewable by a user via a web browser.

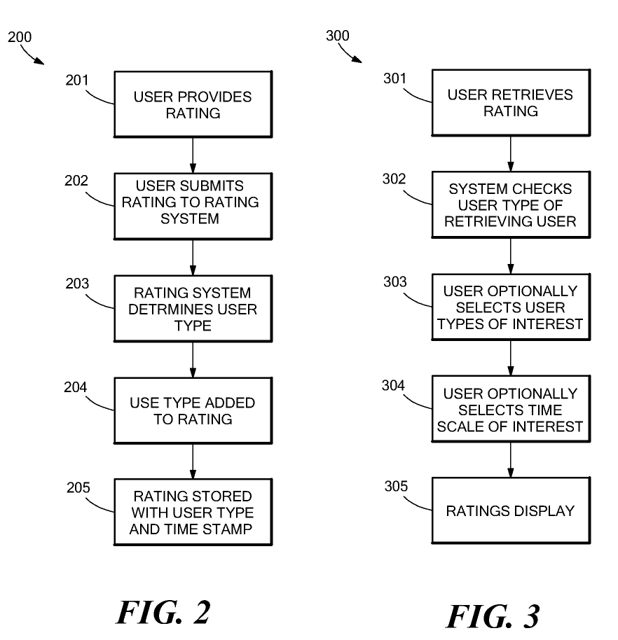

FIGS. 2 and 3 show flow diagrams 200, 300 of method involved in rating system.

FIG. 2 shows a flow diagram 200 of a method of adding a user's rating to a rating system. A user rates 201 an item or service and submits 202 the rating to a rating system. The rating system determines 203 a type of the user and adds 204 a type identifier to the rating. The rating is stored 205 with the user type and a time stamp.

FIG. 3 shows a flow diagram 300 of a method of retrieving ratings. A user retrieves 301 ratings of a particular item or service of interest to the user. The system may automatically check the user type 302 of the retrieving user and display user ratings from the same user types. The system may display the results for a default time period.

As an example default, the system may display a highest rating group of users, a middle rating group of users, and a lowest rating group of users.

Alternatively, the user may select 303 the user groups of interest to him, either the same type as himself or one or more other types. The user may also select 304 the time scale of interest. A representation of the ratings is displayed 305 for the user groups over the time scale of interest.

In one embodiment, a rating system that applies to a document is considered. For example, the document could be a web feed such as an RSS (Really Simple Syndication) feed.

When a user reads a document, he will have the option to rate it on how relevant he found it. This rating will be stored in a database as in conventional system with the time the rating was submitted. A controller then consults the company's employee directory (or user directory for a web site, etc.) to find the user's occupation, for example, a software engineer or a business consultant. This occupation is stored alongside the submitted rating. For example, the user may be a software engineer who gave a page of a web site a rating of 5 out of 10 on the 29 Nov. 2005.

When another user searches for a document that matches the one rated above, the system may check the profession of the new user. The system may then retrieve the ratings given to the returned documents by other users of the same profession and build a graph of the rating given by these individuals over time. This may be represented in a graphical user interface as a graph with three lines, the highest rating group, the lowest rating group, and the middle rating group.

It is possible that a software engineer might want to look at documents that are relevant to business consultants. Therefore, the graphical user interface enables this to be specified.

This system provides a way to distinguish between the users that are giving the system ratings. The user are not necessarily using a search engine to locate documents, so the context of what the user is looking for cannot be determined from the search arguments.

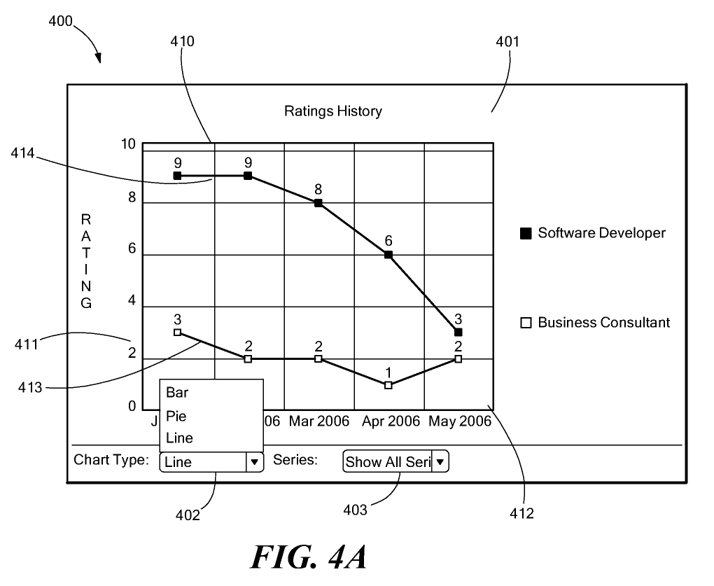

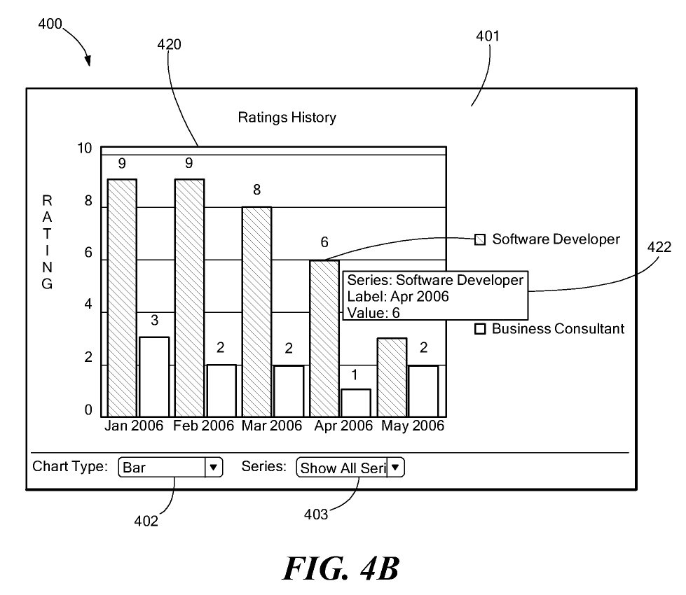

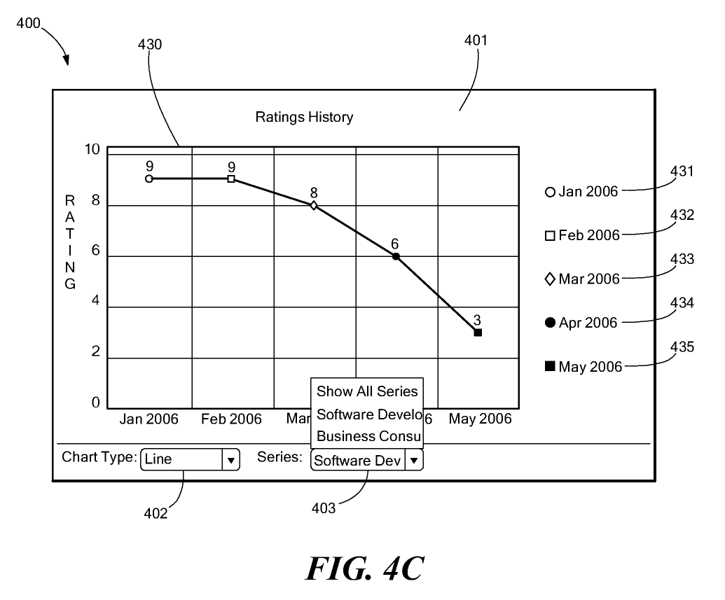

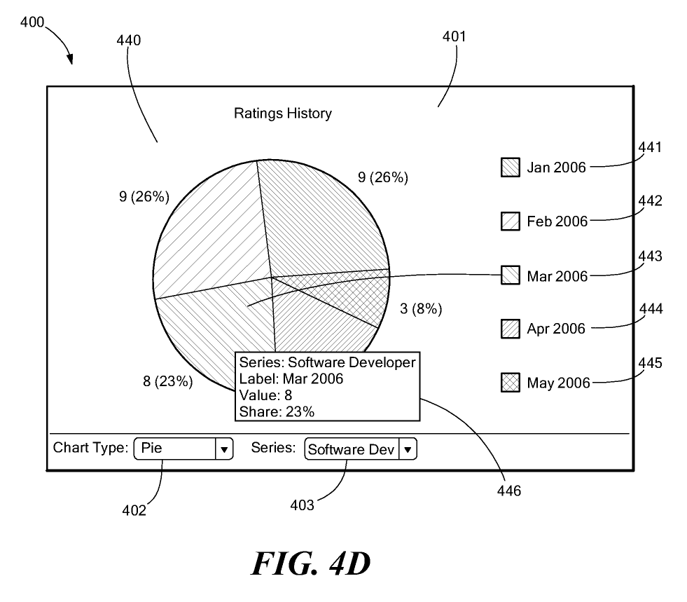

FIGS. 4A to 4D show a graphical user interface 400 with example graphical representations 410, 420, 430, 440 showing ratings of a document relevance with time. The graphical user interface 400 has a graph display area 401. A selection means 402 is provided to select the chart type from a list of options. In this example, the options are a line graph (shown in FIG. 4A), a bar chart (shown in FIG. 4B), and a pie chart (shown in FIG. 4D). A further selection means 403 is provided for selecting the series or user group types. In this example, the options are to show all series (shown in FIGS. 4A and 4B), to show software developers (shown in FIGS. 4C and 4D), or to show business consultants. Different colors may be used to represent the different user groups.

In FIGS. 4A to 4B, the graphical representations 410, 420, 430, 440 are shown grouped in monthly increments for the time period from January to May 2006. It will be appreciated that different time scales may be shown. An additional selection means may be provided for a user to select the time periods shown.

FIG. 4A shows a line graph 410 showing the ratings of a particular document for both a software developer group and a business consultant group. FIG. 4A shows the rating on the y-axis 411 against time shown on the x-axis 412. A first line 413 shows the relevance awarded by business consultants for the period from January 2006 to May 2006. A second line 414 shows the relevance awarded by software developers for the same time period.

In this graph, it can be seen that for a business consultant, the document was never really of any use, and for a software developer, it can be seen that its relevance at May 2006 is fading fast, but maybe useful to a user if he is working with code that originated back in January 2006.

FIG. 4B, shows the same information as a bar chart 420. FIG. 4B shows a label 422 showing the data on hover over by a user with a pointing device, such as a mouse.

FIG. 4C shows a line graph showing just the rating data for a particular document by a software developer group, with color coding for the time periods 431-435 to provide additional clarity of representation. FIG. 4D shows a pie chart showing the same information again color coded for time periods 441-445. FIG. 4D shows a label 446 showing the data on hover over by a user.

This could be extended and customized so that users are not grouped by profession but by team. So a group who are writing documentation can see how relevant the documents they produce are to their target audience, while their target audience can easily tell which documents are relevant to them. As the documents become less relevant, the group who wrote them originally, would be able to see that it is time to review and update them.

The system does not try to determine which is the best document for a user to read and does not recommend anything to the user. The system takes the information it has regarding the ratings given to it by users of the same profession or type and displays this back to the user in form of a graph over time. Thereafter, it is up to the user whether or not they decide to follow the evaluations.

Although the graphical representation shows the user a document's relevance to them over time, indicating that, for example, it is not as relevant now as it was when it was written, that does not necessarily mean that the document is now irrelevant to the user. Its very possible that a user would want a document, for example, for an older version of code. Its relevance at the present time might be very low, but if it had high ratings at the time of the old version the user wants, then this could be exactly what they are looking for. The system could be set up so that a user could search for a document of high relevance in a given time frame. The ratings are never lost, and the relevance over a time frame is easy to calculate.

Also, there is no restriction on the user type that a user can search for. So, if a user is a technical employee but needs a business case for a new project that they are be working on, they may want to find documents useful to business analysts on the same subject, documents that would normally be well outside the user's area of interest or expertise.

The system, compiles ratings for a document from a group of users of a given type, uses this information to build a graphic model of the relevance to a user of a given type and displays this information to the user. Ratings may never be dropped, allowing the user to find ratings of relevance to them from far into the past.

In another embodiment, the rating system could be applied to an on-line service, such as an on-line banking service or on-line store. Users can be grouped according to types such as business, private individuals, or according to geographic location, etc. The rating of the service over time can then be evaluated for a type of user. This can provide valuable information to the service provider who can see if a service is improving in rating or not for a particular group of customers. This information is also useful to other users who may be considering using the service and can see if it has a high rating for their particular type.

A rating system may be provided as a service to a customer over a network.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A rating system comprising:
means for receiving a rating including an indication of the identity of the user;
a directory providing details of user types;
retrieval means for retrieving a user group type from the directory using the indication of the identity of the user;
a storage means for storing the rating together with an indication of the user type and a time stamp.

2. The rating system as in claim 1, wherein the means for receiving a rating is a web site with a rating scale for an item or service.

3. The rating system as in claim 2, wherein the directory comprises one of the set consisting of an employee's directory, a web users' directory, and a directory of user groupings.

4. The rating system as in claim 3, wherein the indication of the identity of the user comprises one of the set consisting of a name, email address, and an Internet Protocol (IP) address.

5. The rating system as in claim 4, including a graphical user interface (GUI) for displaying ratings over time.

6. The rating system as in claim 5, wherein the graphical user interface displays ratings for different user types.

7. The rating system as in claim 6, wherein the displayed user types are configurable by a user.

8. The rating system as in claim 7, wherein the displayed time period is configurable by a user.

9. A method of monitoring ratings, comprising:
receiving a rating from a user;
determining a group type of the user;
storing the rating with a time stamp of the time of submission together with an indication of the group type of the user.

10. The method as in claim 9, further comprising determining an identity of the user.

11. The method as in claim 10, wherein the determining a group type of the user includes retrieving user information from a directory based on the identity of the user.

12. The method as in claim 11, wherein the receiving a rating includes receiving a measure on a rating scale for an item or service.

13. The method as in claim 12, further comprising displaying ratings over time.

14. The method as in claim 13, further comprising displaying ratings for different user types.

15. The method as in claim 14, wherein the displayed user types are configurable by a user.

16. The method as in claim 15, wherein the displayed time period is configurable by a user.

17. A computer program product including a computer readable storage medium, the computer readable storage medium having program code stored thereon for monitoring ratings, the program code comprising:
program code for receiving a rating from a user;
program code for determining a group type of the user;
program code for storing the rating with a time stamp of the time of submission together with an indication of the group type of the user.

18. A method of providing a service to a customer over a network, the service comprising:
receiving a rating from a user;
determining a group type of the user;
storing the rating with a time stamp of the time of submission together with an indication of the group type of the user.
